(19) United States
(12) Patent Application Publication
(10) Pub. No.: US 2026/0180232 A1
(43) Pub. Date: Jun. 25, 2026

(54) ELECTRICAL CONNECTOR, ELECTRICAL TRANSMISSION STRUCTURE AND AUTOMOBILE

(71) Applicant: Changchun Jetty Automotive Technology Co., Ltd., Changchun, Jilin Province (CN)

(72) Inventor: Chao WANG, Changchun (CN)

(21) Appl. No.: 19/129,878

(22) PCT Filed: Nov. 14, 2023
(86) PCT No.: PCT/CN2023/131639

§ 371 Date: May 14, 2025

(30) Foreign Application Priority Data
Nov. 14, 2022 (CN) 202223024011.2

(51) Int. Cl. H01R 13/506; H01R 12/72; H01R 13/52; H01R 13/6581

(52) U.S. Cl. CPC H01R 13/506; H01R 12/724; H01R 13/5205; H01R 13/6581

(57) ABSTRACT

The present disclosure provides an electrical connector, an electrical transmission structure and an automobile. The electrical connector includes a sheath, a shielding shell, a baffle, an inner insulator and at least one inner conductor terminal. The shielding shell includes a shielding cylinder and a first protruding rib which is formed separately from the shielding cylinder and fixedly connected to an outer side of the shielding cylinder. An inner wall of the sheath is provided with a first stop step, the shielding shell is mounted in the sheath, and the first protruding rib abuts against the first stop step. The inner insulator is disposed in the shielding cylinder and is provided with a terminal hole into which the inner conductor terminal is inserted. The baffle is mounted on the inner insulator, and a front side of the baffle abuts against the inner conductor terminal, thereby solving the technical problem of the high production cost of the electrical connector.

### CROSS-REFERENCE TO RELATED APPLICATIONS

The present disclosure claims priority to Chinese Utility Model Patent Application No. 202223024011.2, filed on Nov. 14, 2022, and entitled “Electrical connector, electrical transmission structure and automobile”.

### TECHNICAL FIELD

The present disclosure relates to a technical field of electrical elements, and particularly to an electrical connector, an electrical transmission structure and an automobile.

### BACKGROUND

The High Speed Data (HSD) connector is a high-speed transmission connector, which is mainly used for high-speed signal and current transmission, and currently has been applied in the fields of communications and automobiles. The HSD connector generally includes a sheath, a conductor mechanism and a shielding shell. The conductive mechanism includes terminals and wires, and the shielding shell is mounted in the sheath. In order to ensure the shielding effect, the shielding shell is usually manufactured by means of lathe machining, such that the weight is heavy, and in the actual manufacturing process, the manufacturing cost is high and the manufacturing efficiency is low. Therefore, the production cost of the HSD connector is high, which is not conducive to popularization and application.

### SUMMARY

The present disclosure aims to provide an electrical connector, an electrical transmission structure and an automobile, so as to solve the technical problem that the production cost of the electrical connector is high.

The above objective of the present disclosure can be achieved by adopting the following technical solutions.

The present disclosure provides an electrical connector, including: a sheath, a shielding shell, a baffle, an inner insulator and at least one inner conductor terminal. The shielding shell includes a shielding cylinder and a first protruding rib which is formed separately from the shielding cylinder and fixedly connected to an outer side of the shielding cylinder. An inner wall of the sheath is provided with a first stop step, the shielding shell is mounted in the sheath, and the first protruding rib abuts against the first stop step. The inner insulator is disposed in the shielding cylinder and is provided with a terminal hole into which the inner conductor terminal is inserted. The baffle is mounted on the inner insulator, and a front side of the baffle abuts against the inner conductor terminal.

The present disclosure provides an electrical transmission structure, including the aforementioned electrical connector and a connection device mated with the electrical connector.

The present disclosure provides an automobile, including the aforementioned electrical connector.

The present disclosure has the following characteristics and advantages:

The first protruding rib in the shielding shell may be made of a non-metal material, thereby reducing the weight of the shielding shell and decreasing the material cost and the manufacturing cost. The shielding cylinder realizes a shielding function. Meanwhile, the sheath and the shielding shell are positioned by the first protruding rib, thereby ensuring the accuracy of assembly positioning and the structural stability. The overall weight of the electrical connector is greatly reduced. The inner insulator and the inner conductor terminal are limited by the baffle, which facilitates the assembly, better ensures the assembly quality, reduces the production cost and is beneficial to popularization and application.

### BRIEF DESCRIPTION OF THE DRAWINGS

The following drawings are only for schematic illustration and explanation of the present disclosure, rather than limiting the scope of the present disclosure. In the drawings:

FIGS. 1 to 3 illustrate structural diagrams of an electrical connector according to an embodiment of the present disclosure;

FIG. 4 illustrates an exploded view of the electrical connector illustrated in FIG. 1:

FIG. 5 illustrates a structural diagram of a sheath in the electrical connector illustrated in FIG. 1;

FIG. 6 illustrates an assembly diagram of a sheath and a shielding shell in an electrical connector of the present disclosure;

FIG. 7 illustrates a cross-sectional view of an electrical connector of the present disclosure;

FIGS. 8 and 9 illustrate cross-sectional views of a shielding shell and its internal structure in an electrical connector of the present disclosure;

FIGS. 10 and 11 illustrate structural diagrams of a shielding shell in an electrical connector of the present disclosure;

FIG. 12 illustrates a structural diagram of a shielding cylinder in an electrical connector of the present disclosure;

FIG. 13 illustrates a semi-cross-sectional view of a shielding shell in an electrical connector of the present disclosure;

FIG. 14 illustrates an assembly diagram of a shielding shell and a locking body in an electrical connector of the present disclosure;

FIG. 15 illustrates an assembly diagram of a shielding shell, a locking body and a sheath in an electrical connector of the present disclosure;

FIG. 16 illustrates a structural diagram of a locking body in an electrical connector of the present disclosure;

FIG. 17 illustrates a structural diagram of a rear cover in an electrical connector of the present disclosure;

FIG. 18 illustrates an exploded view of a baffle and an inner insulator in an electrical connector of the present disclosure;

FIG. 19 illustrates an assembly diagram of a baffle and an inner insulator in an electrical connector of the present disclosure;

FIGS. 20 to 23 illustrate structural diagrams of an electrical connector according to another embodiment of the present disclosure; and

FIG. 24 illustrates an exploded view of the electrical connector illustrated in FIG. 20.

### DETAILED DESCRIPTION OF THE EMBODIMENTS

In order to have a clearer understanding of the technical features, objectives and effects of the present disclosure, the specific embodiments of the present disclosure will now be described with reference to the drawings. In the description of the present disclosure, “a plural of” means two or more unless otherwise specified.

### Solution 1

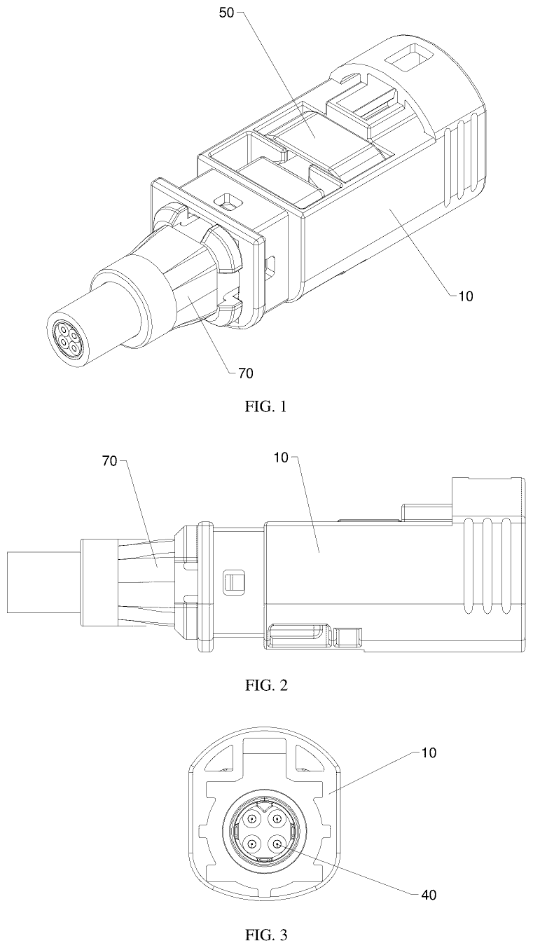

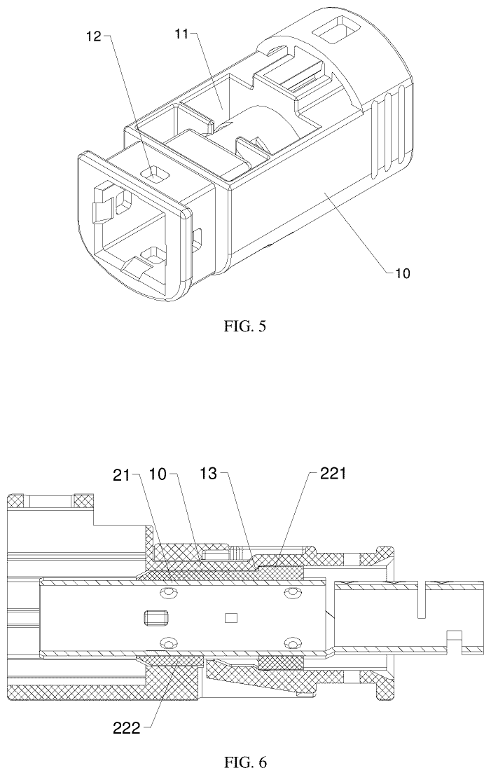

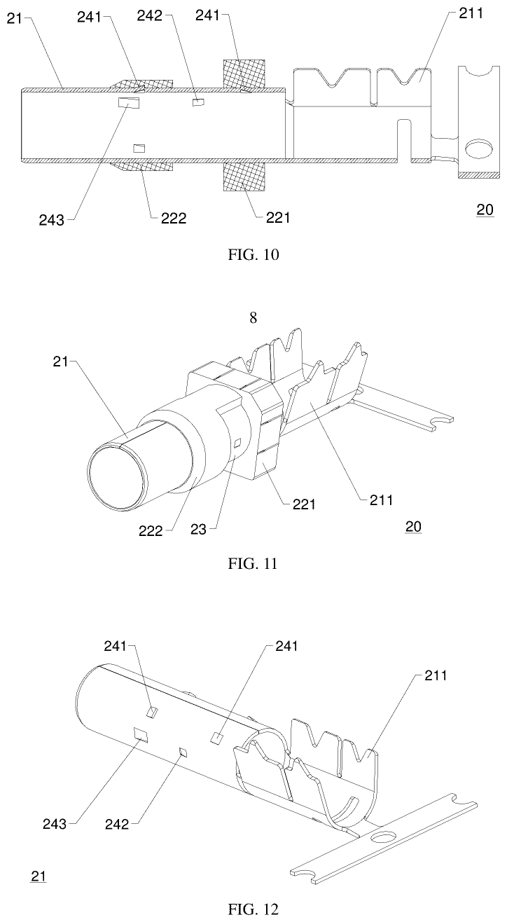

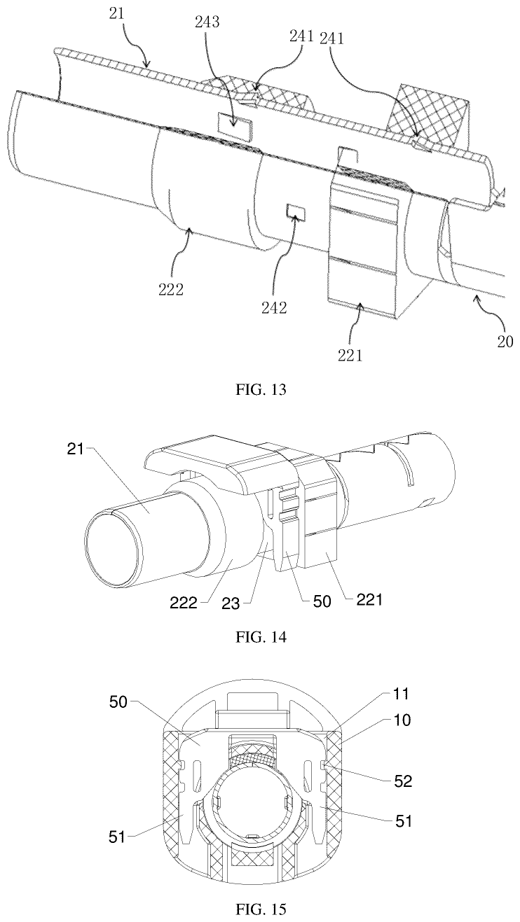

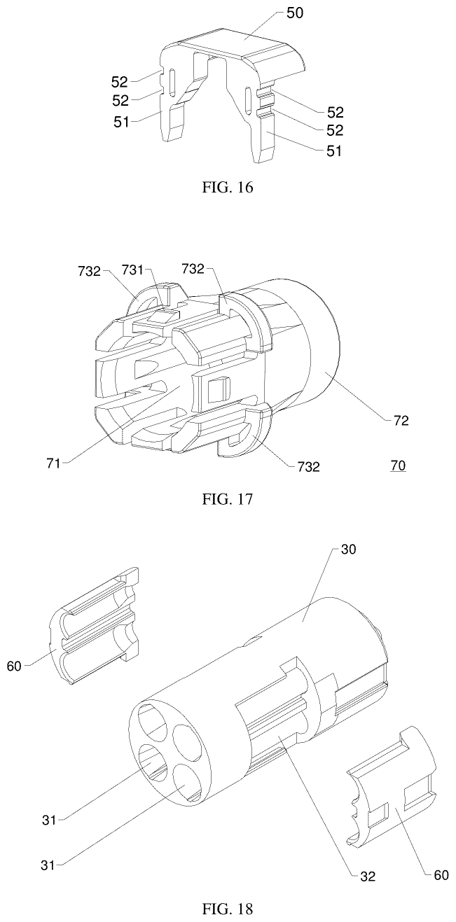

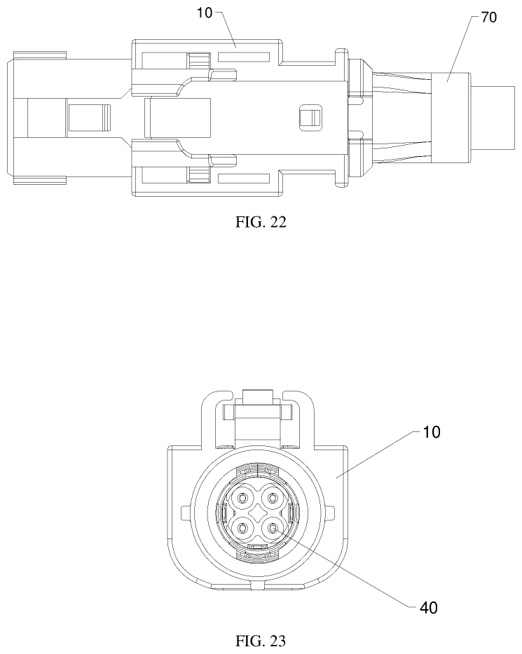

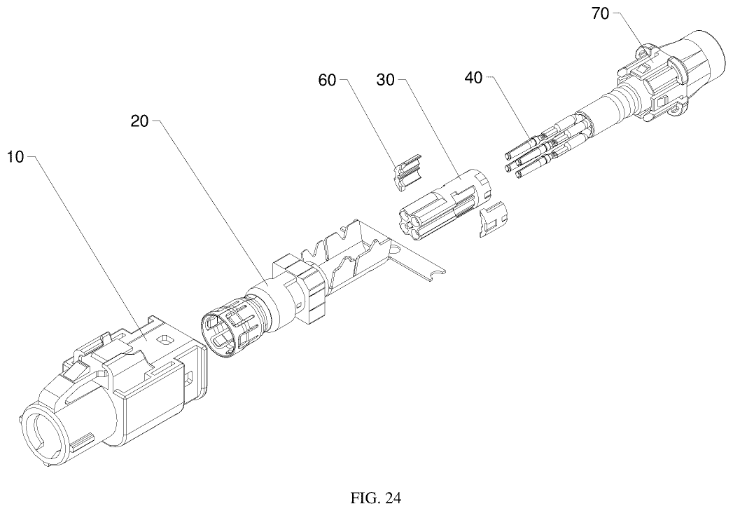

The present disclosure provides an electrical connector, as illustrated in FIGS. 1 to 24, including a sheath 10, a shielding shell 20, an inner insulator 30 and at least one inner conductor terminal 40. The shielding shell 20 includes a shielding cylinder 21 and a first protruding rib 221 which is formed separately from the shielding cylinder 21 and fixedly connected to an outer side of the shielding cylinder 21. The inner insulator 30 is disposed in the shielding cylinder 21, and the inner conductor terminal 40 is disposed in the inner insulator 30. An inner wall of the sheath 10 is provided with a first stop step 13, the shielding shell 20 is mounted in the sheath 10, and the first protruding rib 221 abuts against the first stop step 13.

The shielding cylinder 21 in the shielding shell 20 is made of metal, and the first protruding rib 221 may be made of a non-metal material, thereby reducing the weight of the shielding shell 20 and decreasing the material cost and the manufacturing cost. The shielding cylinder 21 realizes a shielding function. Meanwhile, the sheath 10 and the shielding shell 20 are positioned by the first protruding rib 221, thereby ensuring the accuracy of assembly positioning and the structural stability. The overall weight of the electrical connector is greatly reduced, which is beneficial to popularization and application.

In an embodiment, the shielding shell 20 includes a second protruding rib 222 which is formed separately from the shielding cylinder 21 and fixedly connected to the outer side of the shielding cylinder 21. The second protruding rib 222 is located in front of the first protruding rib 221, and a positioning groove 23 is provided between the first protruding rib 221 and the second protruding rib 222. The electrical connector includes a locking body 50, a sidewall of the sheath 10 is provided with a locking groove 11, and the locking body 50 is inserted into the positioning groove 23 and the locking groove 11. The shielding shell 20 may be inserted into the sheath 10 from a rear end of the sheath 10, and the first protruding rib 221 prevents the shielding shell 20 from moving forward relative to the sheath 10, so as to ensure that the shielding shell 20 is assembled in place in the sheath 10. The locking body 50 prevents the shielding shell 20 from moving backward relative to the sheath 10, thereby positioning a longitudinal position of the shielding shell 20 in the sheath 10, facilitating the assembly and improving the accuracy of assembly positioning.

Further, as illustrated in FIGS. 14 to 16, the locking body 50 includes two locking cantilevers 51 symmetrically disposed. An inner wall of the locking groove 11 is provided with a locking protruding block, and an outer side of the locking cantilever 51 is provided with a locking groove 52. The locking body 50 is inserted into the locking groove 11 in a direction from top to bottom in FIG. 15, and the locking protruding portion is clamped into the locking groove 52 to realize a snap-in fixation between the locking body 50 and the sheath 10. A front side of the locking cantilever 51 abuts against the second protruding rib 222 for longitudinal stopping and limiting.

The first protruding rib 221 may be fixed to the shielding cylinder 21 in various ways, such as clamping or screwing. The second protruding rib 222 may also be fixed to the shielding cylinder 21 in any feasible way. In an embodiment, both the first protruding rib 221 and the second protruding rib 222 are injection molded on the outer side of the shielding cylinder 21. Further, as illustrated in FIGS. 11 to 13, an outer wall of the shielding cylinder 21 is provided with a plurality of first protruding portions 241 formed by stamping, and the first protruding portions 241 are embedded in the first protruding rib 221 and the second protruding rib 222, respectively, thereby being beneficial to improving the firmness between the first protruding rib 221 and the shielding cylinder 21 and the firmness between the second protruding rib 222 and the shielding cylinder 21.

The shielding cylinder 21 may be formed by a stamping process. During stamping, the first protruding portion 241 protruding outward is machined in a circumferential area of the shielding cylinder 21. Next, the first protruding rib 221 and the second protruding rib 222 are injected by an integral injection molding process. During injection molding, the first protruding portion 241 can penetrate into the first protruding rib 221 and the second protruding rib 222, thereby providing a holding force between the first protruding rib 221, the second protruding rib 222 and the shielding cylinder 21. The first protruding rib 221 and the second protruding rib 222 may be made of a resin material, which reduces the overall weight and the production cost of the shielding shell 20. The shielding cylinder 21 is a metal member with good plasticity. The first protruding portion 241 may be formed by stamping and may be a convex hull or a pre-punctured structure.

In an embodiment, the inner insulator 30 is provided with a terminal hole 31, into which the inner conductor terminal 40 is inserted. The electrical connector further includes a baffle 60 mounted on the inner insulator 30, and a front side of the baffle 60 abuts against the inner conductor terminal 40. As illustrated in FIG. 8, the inner conductor terminal 40 may be inserted into the terminal hole 31 in a direction from back to front, and after being inserted in place, the inner conductor terminal 40 abuts against a stepped portion of the terminal hole 31 and is restricted from moving forward any more. Next, the baffle 60 is mounted on the inner insulator 30 to restrict the inner conductor terminal 40 from moving backward relative to the inner insulator 30, thereby realizing the longitudinal positioning between the inner conductor terminal 40 and the inner insulator 30 and facilitating the assembly thereof. The inner insulator and the inner conductor terminal are limited by the baffle, which facilitates the assembly, better ensures the assembly quality and reduces the production cost. Specifically, the inner conductor terminal 40 has the characteristic of variable diameter, thereby forming a forward stop by abutting against the stepped portion, and forming a rearward stop by fitting with the baffle 60.

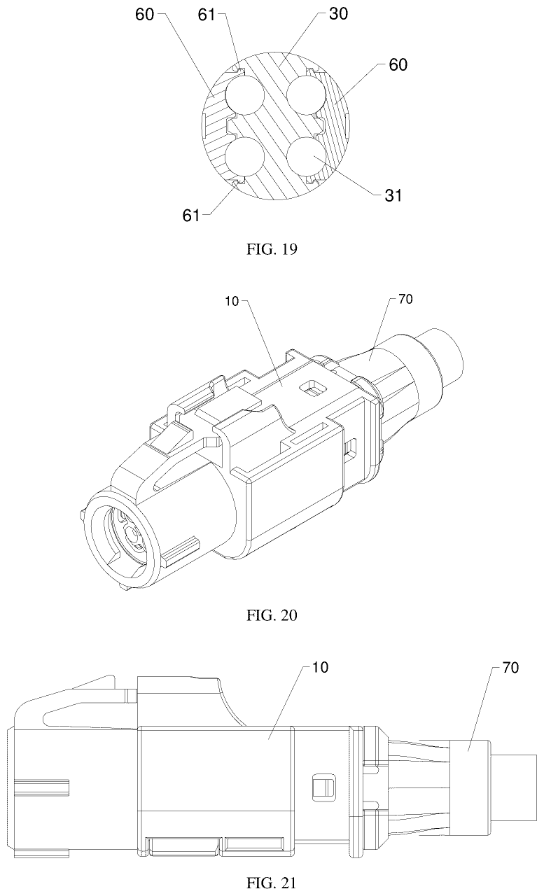

Further, as illustrated in FIGS. 18 and 19, a sidewall of the inner insulator 30 is provided with a mounting groove 32 in which the baffle 60 is mounted, and the baffle 60 and the inner insulator 30 wrap the inner conductor terminal 40. The baffle 60 is provided with a clamping block 61, and the inner insulator 30 is provided with a clamping groove fitted with the clamping block 61, so that the baffle 60 and the inner insulator 30 achieve a snap-in fit, the clamping block 61 is clamped into the clamping groove, and the inner conductor terminal 40 and the baffle 60 form a rearward stop.

After being assembled, the inner insulator 30, the inner conductor terminal 40 and the baffle 60 are together inserted into the shielding shell 20 as a whole. In an embodiment, the outer wall of the shielding cylinder 21 is provided with a second protruding portion 242 formed by stamping, and a front side of the second protruding portion 242 abuts against the baffle 60 to form a rearward stop structure. Further, the outer wall of the shielding cylinder 21 is provided with a third protruding portion 243 formed by stamping, and a rear side of the third protruding portion 243 abuts against the inner insulator 30 to form a forward stop structure. The second protruding portion 242 and the third protruding portion 243 may be formed by stamping, and may be a convex hull or a pre-punctured structure. Exemplarily, as illustrated in FIG. 9, both the second protruding portion 242 and the third protruding portion 243 are pre-punctured structures.

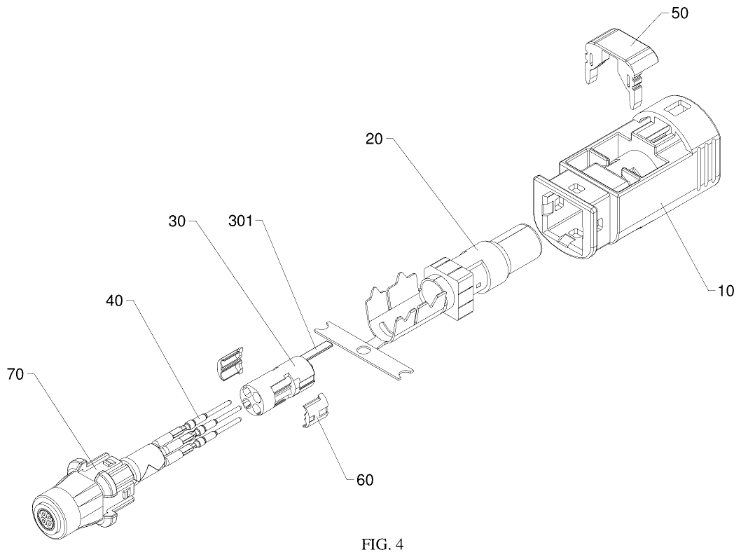

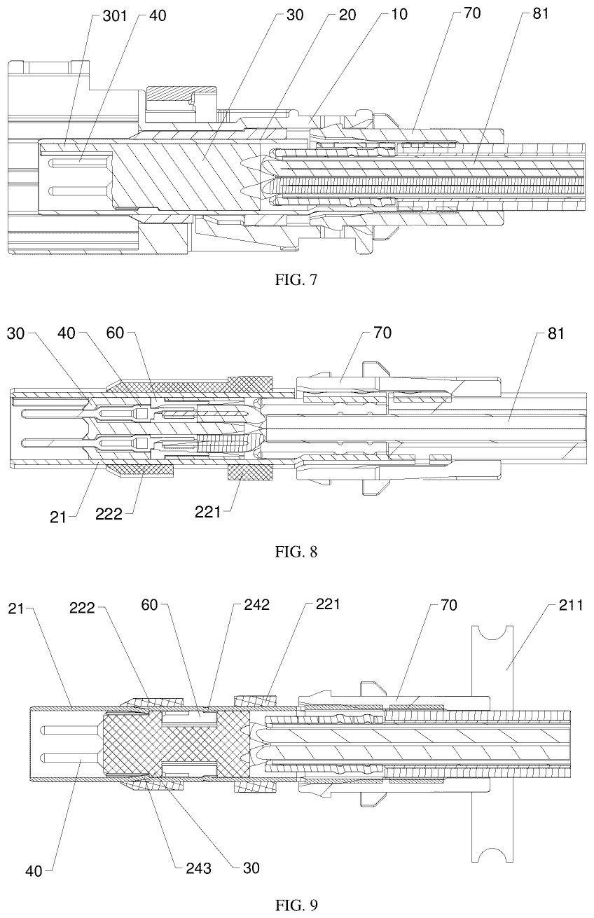

As illustrated in FIGS. 4 and 7, an end of the inner insulator 30 is provided with a guide plate 301, which plays a guiding role, so that the inner insulator 30 and the inner conductor terminal 40 can be mated respectively when the electrical connector is plugged with a mating connection device.

In an embodiment, the electrical connector includes a rear cover 70 provided with a rear cover through-hole 71 for holding a wire harness 81, and the rear cover 70 is mounted at the rear end of the sheath 10. By fixing the rear cover 70 to the sheath 10 and holding the wire harness 81 by the rear cover 70, a radial force of the wire harness 81 is transmitted to the sheath 10 through the rear cover 70, thereby protecting the wire harness 81 and preventing the wire harness 81 from becoming dislodged.

As illustrated in FIGS. 1, 2 and 7 to 9, the rear cover 70 is provided with an elastic arm and a skirt structure 732. The skirt structure 732 serves as an assembly stop. The elastic arm is provided with a protruding structure 731, and the sheath 10 is provided with a rear cover locking hole 12. The wire harness 81 is made to pass through the rear cover 70 in advance. After the shielding shell 20 and the held wire harness 81 are assembled in place, the rear cover 70 is made to snap onto the sheath 10, so that the skirt structure 732 of the rear cover 70 is attached to an end face of the sheath 10 to reach an assembly position, and the protruding structure 731 is made to snap into the rear cover locking hole 12 to form a safe and reliable radial holding protection. Exemplarily, the protruding structures 731 are circumferentially symmetrical, and the skirt structures 732 are circumferentially symmetrical, so that there is no radial directionality during assembly, which is convenient for assembly. Moreover, the rear covers 70 used in a male electrical connector and a female electrical connector have the same structure, which can reduce the number of parts, facilitate the production, and help reduce the production cost.

As illustrated in FIGS. 9 to 12, the shielding shell 20 includes a wire harness crimping portion 211 disposed at a rear end of the shielding cylinder 21. After the wire harness 81 is inserted in place, the wire harness crimping portion 211 is made to contract and curl by a crimping tooling to form a circular ring, so as to be held together with the wire harness 81.

Further, the rear cover 70 includes a protective cylinder 72 in which the wire harness crimping portion 211 is at least partially disposed, and the protective cylinder 72 can provide a safe and reliable radial holding protection function for the wire harness crimping portion 211. The rear cover 70 may be made of an insulating plastic material, and the protective cylinder 72 wraps the wire harness crimping portion 211 while providing radial holding, so as to prevent the metal of the shielding shell 20 from being exposed, protect a joint between the wire harness 81 and the shielding shell 20, avoid the risk of electrical shock, and improve the safety.

In an embodiment, the electrical connector further includes the wire harness 81.

The electrical connector may be a plug or a socket, i.e., the electrical connector may be used as either a male terminal or a female terminal. The electrical connector may also be used as any other electrical connection device. The electrical connector may be an HSD connector, which has the advantages of safety, reliability and light weight. The locking body 50, the baffle 60 and the rear cover 70 can achieve the common use of the male end and the female end.

### Solution 2

The present disclosure provides an electrical transmission structure, which includes the aforementioned electrical connector and a connection device mated with the electrical connector. The electrical connector in the electrical transmission structure may be a male terminal or a female terminal. When the electrical connector is a male terminal, the mated connection device is a female terminal fitted therewith; and when the electrical connector is a female terminal, the butted connection device is a male terminal fitted therewith. The electrical transmission structure includes the technical features and the advantageous effects of the aforementioned electrical connector, which will not be repeated here.

### Solution 3

The present disclosure provides an automobile, which includes the aforementioned electrical connector. The electrical connector may be used for current transmission or signal transmission, and the automobile includes the technical characteristics and the advantageous effects of the aforementioned electrical connector, which will not be repeated here.

Those described above are only illustrative embodiments of the present disclosure, and are not intended to limit the scope thereof. Any equivalent change or modification made by those skilled in the art without departing from the concept and the principles of the present disclosure should fall within the protection scope of the present disclosure.

1. An electrical connector, comprising: a sheath, a shielding shell, a baffle, an inner insulator and at least one inner conductor terminal, wherein:
the shielding shell comprises a shielding cylinder and a first protruding rib which is formed separately from the shielding cylinder and fixedly connected to an outer side of the shielding cylinder;
an inner wall of the sheath is provided with a first stop step, the shielding shell is mounted in the sheath, and the first protruding rib abuts against the first stop step; and
the inner insulator is disposed in the shielding cylinder and is provided with a terminal hole into which the inner conductor terminal is inserted, the baffle is mounted on the inner insulator, and a front side of the baffle abuts against the inner conductor terminal.

2. The electrical connector according to claim 1, wherein;
the shielding shell comprises a second protruding rib which is formed separately from the shielding cylinder and fixedly connected to the outer side of the shielding cylinder;
the second protruding rib is located in front of the first protruding rib, with a positioning groove provided therebetween; and
the electrical connector comprises a locking body, a sidewall of the sheath is provided with a locking groove, and the locking body is inserted into the positioning groove and the locking groove.

3. The electrical connector according to claim 2, wherein both the first protruding rib and the second protruding rib are injection molded on the outer side of the shielding cylinder.

4. The electrical connector according to claim 3, wherein an outer wall of the shielding cylinder is provided with a plurality of first protruding portions formed by stamping, and the first protruding portions are embedded in the first protruding rib and the second protruding rib, respectively.

5. The electrical connector according to claim 1, wherein a sidewall of the inner insulator is provided with a mounting groove in which the baffle is mounted.

6. The electrical connector according to claim 1, wherein an outer wall of the shielding cylinder is provided with a second protruding portion formed by stamping, and a front side of the second protruding portion abuts against the baffle.

7. The electrical connector according to claim 1, wherein an outer wall of the shielding cylinder is provided with a third protruding portion formed by stamping, and a rear side of the third protruding portion abuts against the inner insulator.

8. The electrical connector according to claim 1, wherein the electrical connector comprises a rear cover provided with a rear cover through-hole for holding a wire harness, and the rear cover is mounted at a rear end of the sheath.

9. The electrical connector according to claim 8, wherein the shielding shell comprises a wire harness crimping portion disposed at a rear end of the shielding cylinder; and
the rear cover comprises a protective cylinder in which the wire harness crimping portion is at least partially disposed.

10. The electrical connector according to claim 1, wherein the electrical connector is a plug or a socket.

11. An electrical transmission structure, comprising: the an electrical connector and a connection device mated with the electrical connector, wherein:
the electrical connector comprises a sheath, a shielding shell, a baffle, an inner insulator and at least one inner conductor terminal, wherein the shielding shell comprises a shielding cylinder and a first protruding rib which is formed separately from the shielding cylinder and fixedly connected to an outer side of the shielding cylinder;
an inner wall of the sheath is provided with a first stop step, the shielding shell is mounted in the sheath, and the first protruding rib abuts against the first stop step; and
the inner insulator is disposed in the shielding cylinder and is provided with a terminal hole into which the inner conductor terminal is inserted, the baffle is mounted on the inner insulator, and a front side of the baffle abuts against the inner conductor terminal.

12. An automobile comprising an electrical connector, wherein the electrical connector comprises a sheath, a shielding shell, a baffle, an inner insulator and at least one inner conductor terminal, and wherein:
the shielding shell comprises a shielding cylinder and a first protruding rib which is formed separately from the shielding cylinder and fixedly connected to an outer side of the shielding cylinder;
an inner wall of the sheath is provided with a first stop step, the shielding shell is mounted in the sheath, and the first protruding rib abuts against the first stop step; and
the inner insulator is disposed in the shielding cylinder and is provided with a terminal hole into which the inner conductor terminal is inserted, the baffle is mounted on the inner insulator, and a front side of the baffle abuts against the inner conductor terminal.

13. The electrical transmission structure according to claim 11, wherein:
the shielding shell comprises a second protruding rib which is formed separately from the shielding cylinder and fixedly connected to the outer side of the shielding cylinder;
the second protruding rib is located in front of the first protruding rib, with a positioning groove provided therebetween; and
the electrical connector comprises a locking body, a sidewall of the sheath is provided with a locking groove, and the locking body is inserted into the positioning groove and the locking groove.

14. The electrical transmission structure according to claim 13, wherein both the first protruding rib and the second protruding rib are injection molded on the outer side of the shielding cylinder.

15. The electrical transmission structure according to claim 14, wherein an outer wall of the shielding cylinder is provided with a plurality of first protruding portions formed by stamping, and the first protruding portions are embedded in the first protruding rib and the second protruding rib, respectively.

16. The electrical transmission structure according to claim 11, wherein a sidewall of the inner insulator is provided with a mounting groove in which the baffle is mounted.

17. The electrical transmission structure according to claim 11, wherein an outer wall of the shielding cylinder is provided with a second protruding portion formed by stamping, and a front side of the second protruding portion abuts against the baffle.

18. The electrical transmission structure according to claim 11, wherein an outer wall of the shielding cylinder is provided with a third protruding portion formed by stamping, and a rear side of the third protruding portion abuts against the inner insulator.

19. The electrical transmission structure according to claim 11, wherein the electrical connector comprises a rear cover provided with a rear cover through-hole for holding a wire harness, and the rear cover is mounted at a rear end of the sheath.

20. The electrical transmission structure according to claim 19, wherein the shielding shell comprises a wire harness crimping portion disposed at a rear end of the shielding cylinder; and
the rear cover comprises a protective cylinder in which the wire harness crimping portion is at least partially disposed.
